(19) United States
(12) Patent Application Publication
(10) Pub. No.: US 2026/0054555 A1
(43) Pub. Date: Feb. 26, 2026

(54) Car pod

(71) Applicant: Orville Washington Lyttle, Irvington, AL (US)

(72) Inventor: Orville Washington Lyttle, Irvington, AL (US)

(21) Appl. No.: 18/768,097

(22) Filed: Aug. 25, 2024

(51) Int. Cl. B60J 11/00; B23K 9/23; B60P 3/07; B62D 29/00; B62D 35/00

(52) U.S. Cl. CPC B60J 11/00; B23K 9/23; B62D 35/00; B60P 3/07; B62D 29/008

(57) ABSTRACT

Field of invention: This invention relates to the automotive industry, specifically the hauling of a vehicle.

Problem: An enclosed car hauler was too bulky to fit in a garage, but an open car hauler did not provide security, or protection from the elements when a vehicle is hauled.

Solution: Design a cover to fit on an open car hauler that allows for garaging and provides security and protection from the elements when the car is hauled.

Principal use: Haul a vehicle, in a secure and protective environment, and be able to park the car hauler in a traditional home garage. In addition, the invention increases the aerodynamic qualities of the car hauler, when compared to an enclosed or open car hauler.

The car pod is a cover designed to be attached to an existing car hauler, using hinges and struts. The car pod is lifted from the rear, allowing it to be opened to receive a vehicle driven onto the car hauler. Once the vehicle is secured, the car pod is lowered at the rear and secured. Once closed, the car pod will offer security for a vehicle, protect the vehicle from the elements and increase the aerodynamic properties of the car hauler when it is being hauled.

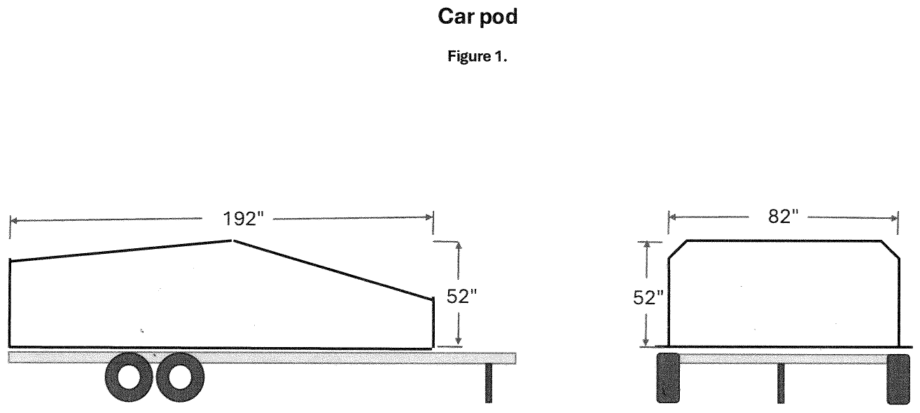

The car hauler is currently made from aluminum; however, it can be made from a variety of, or a combination of materials including, but not limited to ABS Plastic, fiberglass and steel. In its prototype configuration, the car hauler is made with aluminum and has a length of 192 inches, height of 52 inches and a width of 82 inches (see Car pod FIG. 1 Dimensions). The prototype was made specifically for a C7 corvette and attached to a 16 feet aluminum car hauler but can be modified to cover different size vehicles and car haulers up to 20 feet long.

### MATERIALS

1.5″×0.25″ aluminum angle
1.5″×0.25″ aluminum bar
10′×4′×0.30″ aluminum sheet
Stainless steel self-drilling screws

### EQUIPMENT

MIG Aluminum welder and accessories
Miscellaneous tools

### BUILDING PROCESS

Using the specifications of a vehicle, the frame is first made with aluminum angle and flat bar, using the MIG welding process. The completed frame is then attached to the car hauler with hinges at the front and struts for lifting at the sides. The sheet metal is then attached to the frame using self-drilling screws. The sheet metal could be attached with spot welding, adhesive, rivets or screws, but screws were used for the prototype. The completed pod is then raised to allow loading and unloading of a vehicle, with enough clearance to allow strapping to vehicle to the car hauler. The pod is lowered once the vehicle is loaded and strapped to the car hauler and latched and secured at the rear.

The completed prototype, with secured vehicle. was successfully test driven approximately 80 miles.

1. A device used to cover, secure and protect an automobile on a car hauler.
The device is attached to an existing car hauler, using hinges and struts. The device is lifted from the rear, allowing it to be opened to receive a vehicle driven onto the car hauler. Once the vehicle is secured, the device is lowered at the rear and secured. Once closed, the device will offer security for a vehicle, protect the vehicle from the elements and increase the aerodynamic properties of the car hauler when it is being hauled.
The device is currently made from aluminum; however, it can be made from a variety of, or a combination of materials including, but not limited to ABS Plastic, fiberglass and steel.
In its prototype configuration, the device is made with aluminum and has a length of 192 inches, height of 52 inches and a width of 82 inches (see Car pod FIG. 1 Dimensions). The prototype was made specifically for a C7 corvette and attached to a 16 feet aluminum car hauler but can be modified to cover different size vehicles and car haulers up to 20 feet long.
Materials:
1.5″×0.25″ aluminum angle 1.5″×0.25″
Aluminum bar 10′×4′×0.30″
Aluminum sheet
Stainless steel self-drilling screws
Equipment:
MIG Aluminum welder and accessories
Sheet metal cutter Miscellaneous tools
Building process:
Using the specifications of a vehicle, the frame is first made with aluminum angle and flat bar, using the MIG welding process. The completed frame is then attached to the car hauler with hinges at the front and struts for lifting at the sides. The sheet metal is then attached to the frame using self-drilling screws. The sheet metal could be attached with spot welding, adhesive, rivets or screws, but screws were use for the prototype. The completed pod is then raised to allow loading and unloading of a vehicle, with enough clearance to allow strapping to vehicle to the car hauler. The pod is lowered once the vehicle is loaded and strapped to the car hauler and latched and secured at the rear.
The completed prototype, with secured vehicle. was successfully test driven approximately 80 miles.
